(19) United States
(12) Patent Application Publication
(10) Pub. No.: US 2004/0099009 A1
(43) Pub. Date: May 27, 2004

(54) Method for refining a glass melt and an apparatus for melting and refining a glass melt

(76) Inventors: Wilfried Linz, Mainz (DE); Gerhard Nussle, Jena (DE); Gerhard Lautenschlager, Jena (DE); Ferdinand Schultheis, Mainz (DE)

Correspondence Address: WITHROW & TERRANOVA, P.L.L.C., P.O. BOX 1287, CARY, NC, 27512, US

(21) Appl. No.: 10/641,221

(22) Filed: Aug. 8, 2003

(30) Foreign Application Priority Data
Aug. 9, 2002 (DE) DE 102 36 521.0

(51) Int. Cl. C03B 5/225; C03B 5/42

(52) U.S. Cl. 65/135.1; 65/374.12; 65/346; 65/347

(57) ABSTRACT

The invention relates to a melting cistern for producing a glass melt as well as to its refining,

with a cistern floor which is situated by a dimension H beneath the melt level;

with a refining wall which extends in the transversal direction over the cistern width B and whose upper edge is situated by a dimension H beneath the melt level;

with a weir being provided in the refining wall which forms an overflow edge for the melt and which consists of a sheet metal plate made of molybdenum or tungsten or a refractory metal or an alloy made of refractory metals;

with the weir standing in the glass bath in a completely free manner in its upper region.

The invention relates to a method for refining a glass melt and further to an apparatus for melting and refining inorganic compounds, especially glass shards and/or a glass mixture. A continuous process is referred to in particular.

Numerous apparatus are known with which the said materials can be molten or refined. The invention relates to glass melting furnaces which comprise a melting cistern. The melting cistern comprises a melting zone and a refining zone. These two zones are separated from each other by a wall, which is generally referred to as “refining wall” or “overflow wall”. The melting cistern comprises a floor on which the wall stands. Its upper edge is situated during the operation of the glass melting furnace below the melt level by a certain amount.

Such melting cisterns comprise an upper furnace heating. For this purpose a number of burners are provided. They are used for supplying air or oxygen as an oxidation medium for the supplied fuel.

Blast nozzles can further be provided in front of the wall. They are located in the floor of the melting cistern, namely in front of the wall. They are arranged in rows which extend transversally to the longitudinal direction of the cistern and thus to the direction of flow of the melt. They are used for supplying gases.

Electrodes, which are anchored in the floor, are also frequently provided in front of the wall and also transversally to the main direction of flow. A transversal or longitudinal heating as well as a Scott connection are also possible.

The blast nozzles and electrodes have the following function: The swell point region of the melt must be situated before the wall. The glass needs to be heated to such a high extent there that in the heated state it does not slump when flowing over the wall, but remains in the surface region. The blast nozzles and/or the additional electric heating support the effect of the wall to a considerable extent (cf. the publication of Trier, “Glasschmelzöfen” (“Glass melting furnaces”), Springer-Verlag 1984, Section 2.4.3. III. 2.9 shows a borosilicate glass melting cistern made of ceramic material).

EP 0 864 543 B1 explains the effect of the blast nozzles (cf. page 4, lines 31 ff. cit. loc.). Accordingly, the blast nozzle bubblers produce a flow circulation, whereby it draws glass from below and transports the same to the surface of the glass bath. In this process, cooler glass sinks quicker than hotter glass. Within the flow circulation there is a separation of hot and cold glass.

This effect is reduced by the arrangement of a row of electrodes. It leads to an upward flow which ensures that the glass is transported mainly to the surface and that a return flow is reduced.

From the publication “HVG-Fortbildungskurse 1998” (HVG courses for further education), Verlag der DGG, 1998, pages 30-33 a glass melting cistern has become known which comprises a wall made of wall bricks with a molybdenum insert.

Every overflow wall is subject to heavy wear and tear. It is subjected to corrosion in the course of its service life and thus to gradual wear and a reduction in its service life. The effectiveness of the refining decreases with increasing glass cover.

In order to increase the service life of ceramic walls in the glass, built-in walls are cooled nowadays by means of air or water through bores in the bricks. The cooling comes with the disadvantage that so much heat is removed from the overflowing glass that it will not remain in the surface region after the wall. This can lead to the removal of insufficiently refined glass from the melting cistern. Until the cooling becomes effective, the distance between the glass surface and the wall surface is increased considerably by corrosion. There have been numerous proposals and tests to arrange a highly drawn up step as a so-called refining bench in the melting cistern after the swell point instead of a wall in order to hold the glass to be refined in a forced manner for a longer period close to the glass bath surface during the overflowing. Such a refining bench is protected in EP 086 4 543. The refining bench has a length of 800 to 2,000 mm in the direction of the glass flow and in the height a distance of a maximum of 300 mm from the constructionally provided glass bath surface. Such a refining bench has the disadvantage that the glass remains in contact with the refractory material of the refining bench at the usually high refining temperatures of over 1,600° C. The impurification of the finally refined glass with the corrosion products of the refractory material cannot be excluded. Due to wear and tear of the refractory material, the height of the refining bench does not remain constant over the cistern width during the cistern migration. This can lead to preferred flow paths of the glass on the refining bench and to the supply of insufficiently refined glass.

The invention is based on the object of providing a method for refining a glass melt which is characterized by a high efficiency, especially by avoiding the delivery of unrefined glass at a low amount of effort involved. With respect to the apparatus it is provided to arrange in a melting cistern a non-cooled wall which remains high over the entire service life and which is made of materials which are resistant to molten glass at high temperatures, such that in cooperation of upper furnace heating and optional direct electric heating of the glass before the wall the glass rises in a swell zone extended over the entire cistern width with the lowest possible speed which is evenly distributed. A temperature increase of the glass of 50 to 150 K with a simultaneous pressure relief of 0.2 to 0.3 bars is to be achieved.

The solution in accordance with the invention is characterized by the features of claim 1.

In accordance with the invention, a glass melt is guided for refining over a refining wall which substantially consists of a plate which is arranged transversally and perpendicularly to the direction of flow of the glass melt. It forms a weir.

The effect of the plate is as follows: The hot glass melt is conveyed in the direction of flow of the melt upwardly before the plate towards the glass bath surface and also remains behind the plate for a longer period of time and over a long path on the glass bath surface. There is thus sufficient time and space on the surface in order to refine the glass melt effectively. The bubbles rise from the hot and thus low-viscous glass melt from the glass bath surface. The glass melt per se has a sufficiently high temperature over a longer period of time and over a longer distance (e.g. up to a distance of 3 m behind the plate) and is sufficiently long at the surface. It is furthermore only in contact with a relatively small surface of refractory material at the edges of the melting cisterns or the refining section of the melting cistern. The wear and tear of refractory materials by the holter gas melt is therefore much lower as compared with the refining walls known from the state of the art.

The inventors have thus recognized that with a plate which is arranged in accordance with the invention transversally and perpendicularly to the direction of flow of the glass melt it is possible to provide a better and more economical refining than was possible with previously known designs.

In accordance with the invention, the thickness of the plate is chosen in such a way that it withstands the flow forces of the glass melt. Larger thicknesses are not required. The thickness of the plate is thus obtained as a function of the force produced by the flowing glass melt on the surface area acting on the plate, so that a counterforce of at least the same magnitude is produced by the same without the plate tearing from its fastening or anchoring or deforming in a strongly elastic manner.

A sheet metal plate of a refractory metal or of an alloy made of a refractory metal is preferably used as a plate. Molybdenum or tungsten or alloys formed by the same are preferably used. The plate per se is rigidly fastened to the melting cistern or joined to at least one part of the melting cistern, depending on the arrangement of the melting cistern.

The principal idea of the invention is thus the arrangement of a weir formed by means of a plate from a material which is corrosion-proof or substantially corrosion-proof. Potential materials are refractory metals such as molybdenum or tungsten or alloys from the same.

The plate can preferably be of an integral design or consists of a plurality of mutually joined partial plates. The bearing or fastening of the plate occurs at least indirectly in the cistern, i.e. either directly on the cistern wall or by means of anchoring means arranged in the same.

The weir can have the shape of a plate which is only a few centimeters thick, e.g. between one and five centimeters. It can also be thicker or less thick. The weir comprises a substantially preferably horizontal overflow edge. The same is situated during operation at a low distance beneath the level of the melt, e.g. at a distance of 25 to 250 mm. A range of between 50 and 150 mm is also possible.

The weir or plate need not necessarily extend up to the cistern floor. The lower regions can thus also be formed from a different material, e.g. a refractory material. The background of the invention is the following:

Since the weir or the plate does not corrode as a result of the chosen material, the upper edge always remains at one and the same geodetic level, namely not only for many months but in the course of a complete cistern life. This means that at a given level of the melt in the cistern the overlap (i.e. the vertical distance between the upper edge of the weir or plate and the melt level) remains unchanged.

This means again that the overlap can be provided with a very small dimension. The melt layer which flows over the upper edge of the weir or plate is therefore relatively thin.

It follows from this that the path that the individual bubble located in the melt has to cover in the region of the overflow edge of the weir and further downstream towards the melt level is short. The emergence of bubbles from the melt is thus promoted in this way.

It is known that that the temperature of the melt bath increases from the bottom to the top. This means that the temperature of the melt is higher in the region of the liquid level than in the region of the cistern floor. Since the upper edge of the weir is situated close to the melt level, only melt flows over the upper edge of the weir which has an especially high temperature. Since the viscosity of this very high layer of the overflowing melt is also very low, the rise of bubbles from the melt to the liquid level is promoted again.

The advantages of the invention can also be characterized as follows:

a release of refining gases predominantly consisting of oxygen, halogenides or sulfate from the glass;

the diffusion of refining gases into any remaining residual bubbles in the glass;

an increase of the residual bubbles;

the diffusion of gases dissolved in the glass into the enlarged bubbles;

the dwelling of the rising gas on the glass bath surface after flowing over the wall;

an emergence of up to 100% of the enlarged bubbles from the glass bath surface.

In summary, the following can be said:

By applying the invention the refining effect will become more efficient relating to the unit per volume of the melt to be treated. This means that in the melt region as well as the refining region lower temperatures can be used for achieving a certain glass quality or that as an alternative thereto a higher throughput can be achieved at a specific desired glass quality and at the same temperature level.

It is thus possible to positively influence either individually or in combination the parameters of glass quality, throughput and energy input by the invention.

The invention is explained in closer detail by reference to the enclosed drawings, wherein:

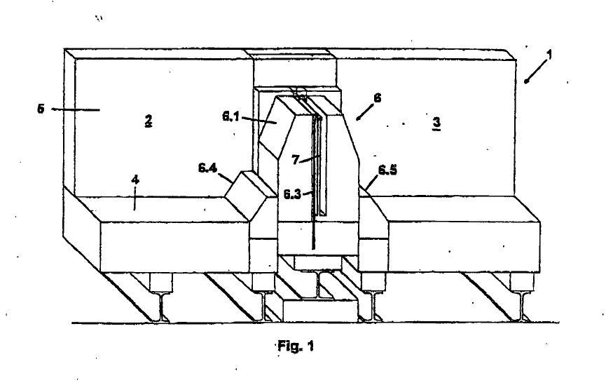

FIG. 1 shows a perspective view of a wall of a glass melting furnace. One of the longitudinal sides has been omitted. The wall comprises a weir which is lined with refractory material.

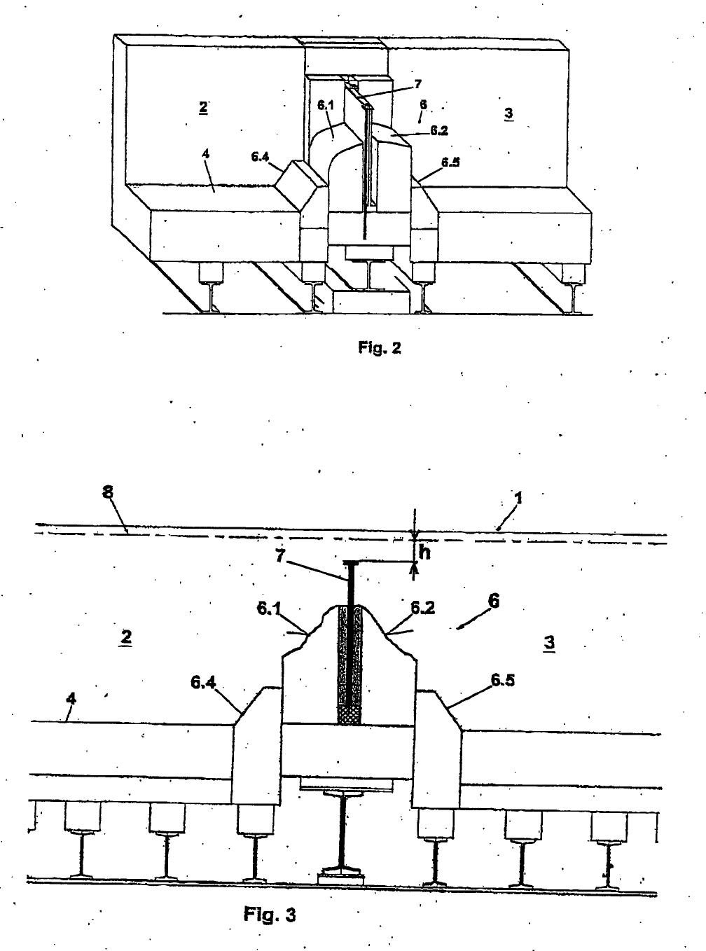

FIG. 2 shows a second embodiment of a melting cistern in accordance with the invention. The illustration corresponds to that of FIG. 1. The weir is only fully effectively maintained in the original state in the glass melt after the refractory material has corroded away.

FIG. 3 shows a third embodiment of a melting cistern in accordance with the invention in an elevated view. The weir is lined only partly with refractory material.

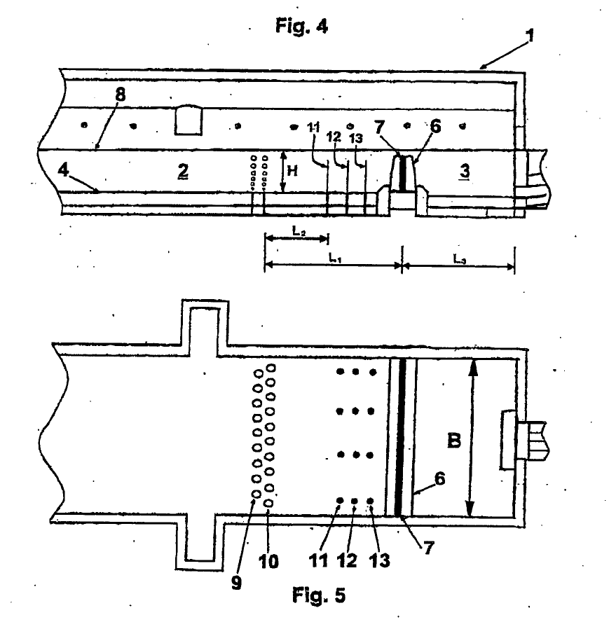

FIG. 4 shows a fourth embodiment of a melting cistern in a schematic representation.

FIG. 5 shows the melting cistern according to FIG. 4 in a top view.

The apparatus as arranged in accordance with the invention and as shown in FIG. 1, in particular a melting cistern 1 of a glass melting furnace, comprises a melt region 2 and a refining region 3, and further a cistern floor 4. Only one wall 5 is shown of the two longitudinal side walls. The other longitudinal side wall has been omitted for reasons of clarity of the illustration, as also the two face walls.

It is also possible to use a refractory lining which is only provided with a protective oxidation layer or which is configured for operation under a protective furnace gas or a reducing atmosphere.

Melt region 2 and refining region 3 are separated from each other by a refining wall 6. As can be seen, the refining wall 6 projects perpendicularly from the cistern floor 4.

A weir in the form of a plate 7 is integrated in the refining wall 6. It concerns a plate 7 which extends over the width of the inner space of melting cistern 1, i.e. between the two longitudinal side walls. It can also concern a continuous plate 7 as well as several plates fastened to each other. The plate extends transversally and perpendicularly to the direction of flow of the glass melt.

As can be seen, plate 7 has been inserted into a gap space in the refining wall 6. In the illustrated state the same is immersed fully, so that the upper edge of the weir is situated at the same level as the upper edge of the refining wall 6.

The upper edge of the plate 7 is situated by a distance h below the melt level 8 (h=50 to 250 mm, preferably 100 mm).

In the embodiments according to FIGS. 1 to 3 a step 6.4, 6.5 each is situated in front of the refining wall 6 and behind the same. Said steps have proved to be useful in the case of larger bath depths concerning the achievement of the object in accordance with the invention.

In a further embodiment of a cistern 1 for a glass melting furnace according to FIGS. 4 and 5 one can recognize further details.

Two rows 9, 10 of blast nozzles are provided. They are arranged in the cistern floor 4. They extend transversally to the longitudinal direction of the cistern 1, and thus in the main direction of flow.

Three rows 11, 12, 13 of electrodes are provided downstream of the blast nozzles 9, 10.

The row of blast nozzles and the rows of electrodes are situated before the refining wall 6.

Notice must be taken of the following dimensions: The inside width of the cistern space is B (see FIG. 5).

The melt level is H (see FIG. 4). This means in other words that the cistern floor 4 is situated by the dimension H below the melt level 8.

The distance between the row of blast nozzles 10 and the weir, and in particular the plate 7, is L₁. Generally, L₁ is two to five times the dimension H. It can also assume a value in between, e.g. three times or four times or 4.5 times.

The distance L₂ between the row 10 of blast nozzles which is the last one in the main direction of flow and the row 11 of electrodes which is the front one in the main direction of flow is generally 0.5 to 3 times the dimension H. It can also lie within said range, i.e. one time or 1.5 times the dimension.

The weir, and especially the plate 7, has a distance L₃ to the downstream face wall of cistern 1 as seen in the main direction of flow, i.e. in the longitudinal direction of the cistern 1.

According to a preferred embodiment of the invention, it is provided that the weir, and in particular plate 7, consists of a sheet metal made of molybdenum, tungsten or alloys predominantly containing Mo or Wo or other refractory metals of low thickness with the dimensions up to the cistern width B×glass bath height H and is reinforced by supporting elements made of suitable refractory metals which are anchored in the cistern floor and can thus stand freely in the glass bath in an non-cooled fashion. Supporting elements are not necessary in the case of lower cistern widths.

The refining wall 6 can comprise the further following features:

It is built into an airfuel cistern heated recuperatively or regeneratively or into an oxyfuel cistern with or without EZH.

It is suitable for all glasses to be refined, e.g. for soda-lime glasses, alkaline borosilicate glasses, alkali-free borosilicate glasses or aluminosilicate glasses.

It is suitable for all useful refining agents, e.g. oxidic refining agents such as As₂O₃, Sb₂O₃, SnO₂, CeO₂, MoO₃, halogenides such as LiCL, NaCl, KCl, BaCl₂, SrCl₂ or sulfates.

The sheet metal of the refining wall is embedded on the two side walls (palisades) between special palisade bricks.

During the tempering of the cistern, the sheet metal of the refining wall is protected by coating and/or covering with glass slabs and glass grains against oxidation or it is molten down in a reducing manner.

When the cistern is fully filled with melt, the glass pressures resulting in front of and behind the wall from the different glass levels are absorbed by the wall bricks or supports installed in front of or behind the Mo or Wo sheet.

When the cistern is fully filled with melt from both sides, wall bricks or supports can be omitted.

The sheet of the refining wall stands in a non-cooled manner in full height in the glass bath even during progressing corrosion of the wall bricks, so that the function of the refining wall during the entire cistern life is ensured without any limitations.

The sheet of the refining wall can be coated or lined with suitable refractory materials for protection against corrosion.

A refining wall 6 in accordance with the invention can thus remain non-cooled. It is suitable for refining glasses with high demands made on freedom from bubbles and residual gas contents in the basin of a glass melting furnace with upper furnace heating and optional direct electrical heating via electrodes in the glass bath consisting of a melting part, refining part and a flow-through for removing the molten and refined glass. Corrosive products of the wall material are avoided, e.g. streaks or particles.

The refining wall 6 in accordance with the invention is appropriately arranged in such a way that in cooperation with the upper furnace heating by means of burners and optionally electric heating with at least one row of electrodes and/or at least one row of blast nozzles transversally to the glass flow, any glass containing residual bubbles will rise evenly over the cistern width at temperatures over 1,600° C. (or lower temperatures) in such a slow manner that during the rise an increase in the temperature of the glass of 50 to 150 K is achieved at a simultaneous pressure relief of 0.2 to 0.3 bars and the glass remains on the glass bath surface after flowing over the wall due to its lower density relative to the glass after the wall and sufficient periods of time are ensured thereby, so that refining gases released in the rising glass flow as well as gases such as CO₂, H₂O, N₂, SO₂ which are dissolved in the glass will diffuse into the residual bubbles and enlarge the same to such an extent that they will rise to the glass bath surface after the wall and can emerge from the border layer of the glass bath surface and upper atmosphere.

The principal idea of the invention is the said plate 7 which is present in particular as a sheet metal plate. If it is situated at all times below the melt level then there is no or only a very low likelihood of corrosion.

The bricks of the refining wall 6 assume a protective function and support for the plate 7. Plate 7 retains its function.

1. A method for refining a glass melt, characterized in that the glass melt is guided over a refining wall (6), with the refining wall (6) substantially consisting of a plate (7) extending transversally and perpendicularly to the direction of flow of the glass melt.

2. A method as claimed in claim 1, characterized in that a plate (7) made of a refractory metal or of an alloy of a refractory metal is used as a plate (7).

3. A method as claimed in one of the claims 1 or 2, characterized in that a plate made of molybdenum or tungsten or its alloy is used as a plate (7).

4. A method as claimed in one of the claims 1 to 3, characterized in that a plate is used as a plate (7) which is held in a stationary manner with the melting cistern (1), with the same being connected with at least a part of the melting cistern (1).

5. A method as claimed in one of the claims 1 to 4, characterized in that the thickness of the plate (7) is chosen as a function of the flow forces of the glass melt in such a way that as a result of the same at least one counter-force to the flow force of the glass melt is produced which corresponds to the same with respect to magnitude without causing any deformation or detachment of the connection of the plate (7) with the cistern (1).

6. An apparatus for melting and refining a glass melt, in particular a melting cistern (1),
6.1 with a cistern floor (4) which is situated by a dimension H beneath the melt level (8);
6.2 with a refining wall (6) which extends in the transversal direction over the cistern width B and whose upper edge is situated by a dimension H beneath the melt level (8);
6.3 with the refining wall (6) substantially consisting of a plate (7) which forms a weir and is arranged transversally and perpendicularly to the direction of flow of the melt.

7. An apparatus as claimed in claim 6, characterized in that the plate (7) stands freely in the glass bath in at least its upper region.

8. An apparatus as claimed in claim 6 or 7, characterized in that the plate (7) forms an overflow edge for the melt and consists of a corrosion-proof material.

9. An apparatus as claimed in one of the claims 6 to 8, characterized in that the plate (7) consists of a refractory metal or an alloy of refractory metals.

10. An apparatus as claimed in claim 9, characterized in that the plate (7) consists of a sheet metal plate made of molybdenum or tungsten or their alloys.

11. An apparatus as claimed in one of the claims 6 to 10, characterized in that the plate (7) is connected with the melting cistern (1) or is rigidly anchored in parts of the melting cistern (1).

12. An apparatus as claimed in one of the claims 6 to 11, characterized in that the thickness of the plate (7) is chosen as a function of the flow forces caused by the flowing glass melt in such a way that it can withstand the flow forces.

13. An apparatus as claimed in one of the claims 6 to 12, characterized by the following features:
13.1 the cistern floor (4) comprises rows (9, 10) of nozzles for introducing gases into the melt, which rows extend transversally to the longitudinal direction of the melting cistern (1);
13.2 the cistern floor (4) comprises rows (11, 12, 13) of electrodes which extend transversally to the longitudinal direction of the melting cistern (1) and are provided downstream of the rows (9, 10) of nozzles in the direction of flow;
13.3 the distance L₁ between the nozzles (10) which are the last ones in the direction of flow and the refining wall (6) is two to fives times the dimension H
13.4 the distance L₂ between the nozzles (10) which are the last ones in the direction of flow and the electrodes (11) which are the front ones in the direction of flow is 0.5 to 2 times the dimension H.

14. An apparatus as claimed in one of the claims 1 to 13, characterized in that the horizontal distance L₃ between the plate (7) and the downstream face wall of the cistern (1) is at least two to three times the dimension H.

15. An apparatus as claimed in one of the claims 1 to 14, characterized in that the plate (7) is embedded between palisade bricks on the two side walls of the melting cistern (1).

16. An apparatus as claimed in one of the claims 6 to 15, characterized in that the plate (7) is protected against oxidation during the start tempering of the melting cistern (1) by coating and covering with glass slabs and glass grains.
